(19) United States
(12) Patent Application Publication
(10) Pub. No.: US 2024/0348078 A1
(43) Pub. Date: Oct. 17, 2024

(54) BATTERY MANAGEMENT SYSTEM AND CONTROL CIRCUIT AND CONTROL METHOD THEREOF

(71) Applicant: TRITIUM ELECTRONICS PTE. LTD., Singapore (SG)

(72) Inventors: Tse-Ju Liao, Hsinchu (TW); Zhi-Xin Chen, Hsinchu (TW); Tai-Yu Lu, Hsinchu (TW); Pao-Cheng Chiu, Hsinchu (TW)

(21) Appl. No.: 18/454,044

(22) Filed: Aug. 22, 2023

(30) Foreign Application Priority Data
Apr. 14, 2023 (CN) 202310401965.0

(51) Int. Cl. H02J 7/00

(52) U.S. Cl. CPC H02J 7/007182

(57) ABSTRACT

A battery management system includes a MOSFET unit and a control circuit. The MOSFET unit includes a charging MOSFET and a discharging MOSFET, wherein the MOSFET unit is coupled to a positive side power path to control charging and discharging a battery. In a process of turning OFF discharging MOSFET, the control circuit is configured to operably electrically connect a gate-source capacitor of the discharge MOSFET to a discharge level for discharging the gate-source capacitor, and determine to stop discharging the gate-source capacitor according to a difference of a pack pin voltage and a discharge pin voltage, wherein the discharge level is lower than the pack pin voltage.

### CROSS REFERENCE

The present invention claims priority to CN 202310401965.0 filed on Apr. 14, 2023.

### BACKGROUND OF THE INVENTION

### Field of Invention

The present invention relates to a battery management system; particularly, it relates to such battery management system that discharges a gate-source capacitor of a discharge metal oxide semiconductor field effect transistor (MOSFET) in a process of turning OFF the discharge MOSFET. The invention also relates to a control circuit and a control method of a battery management system.

### Description of Related Art

FIG. 1 shows a prior art battery management system. As shown in FIG. 1, a battery management system 100 includes a MOSFET unit 110 and a control circuit 120. The MOSFET unit 110 includes a charge MOSFET 111 and a discharge MOSFET 112 for controlling charging and discharging of a battery 130. When the charge MOSFET 111 and the discharge MOSFET 112 are N-type MOSFETs (NMOSFETs), the MOSFET unit 110 is coupled to a positive side power path of the battery 130 which is between a battery positive voltage end VBAT+ and a battery pack positive voltage end PACK+ as shown in FIG. 1, to control a charging current and a discharging current of the battery 130.

As shown in FIG. 1, the control circuit 120 is an IC chip with a plurality of pins for controlling the charge MOSFET 111 and the discharge MOSFET to control the 112 charging/discharging current, so as to charge/discharge the battery 130. Switch turn-OFF operation circuits 121 and 122 are respectively used to control a turn-OFF process of the charge MOSFET 111 and the discharge MOSFET 112. When the control circuit 120 controls the battery 130 to operate in charging, discharging, over-current protection, or other operation modes, and the charge MOSFET 111 needs to be turned OFF, a process of turning OFF the charge MOSFET is entered. In the process of turning OFF the charge MOSFET, the switch turn-OFF operation circuit 121 turns ON a switch SW1 to electrically connect a charge control pin CHG and a battery voltage pin VBAT, so that a gate and a source of the charge MOSFET 111 are electrically connected, and then a gate-source voltage of the charge MOSFET 111 is lowered to turn OFF the charge MOSFET 111. On the other hand, when it is necessary to turn OFF the discharge MOSFET 112, it enters a process of turning OFF the discharge MOSFET, and in the process of turning OFF the discharge MOSFET, the switch turn-OFF operation circuit 122 turns ON the switch SW2 to electrically connect a discharge control pin DSG and a battery pack pin PACK, so that a gate and a source of the discharge MOSFET 112 are electrically connected, and then a gate-source voltage of the discharge MOSFET 112 is lowered to turn OFF the discharge MOSFET 112. In addition, current sensing pins SNS1 and SNS2 of the control circuit 120 are coupled between a battery negative voltage end VBAT− and a battery pack negative voltage end PACK− to sense the charging/discharging current flowing through the battery 130. The control circuit 120 has other circuits and signals to control conductions of the charge MOSFET 111 and the discharge MOSFET 112, which are not the focus of the present invention and will not be described here.

FIG. 2 shows a schematic waveform diagram of related signal of the battery management system 100 of the conventional art. As shown in FIG. 2, a time period from a time point t1 to a time point t2 shows a period of the turn-OFF process of the discharge MOSFET 112. At the time point t1, the switch turn-OFF operation circuit 122 generates a switch turn-ON voltage Vsw2 (switched to a high potential) to turn ON the switch SW2. In the turn-OFF process of the discharge MOSFET 112, the gate-source capacitor of the discharge MOSFET 112 is discharged only by a discharge path formed by a parasitic conductive resistor of the switch SW2, so as to reduce the gate-source voltage of the discharge MOSFET 112. In addition, the potential of the source end will decrease with the response of the pack pin voltage Vpack at the load end (that is, the battery pack high-voltage end PACK+, electrically connected to the battery pack pin PACK), which makes the turn-OFF speed of the discharge MOSFET 112 need tens of milliseconds to hundreds of milliseconds (ms). As a result, the time period required to turn OFF the operation of the discharge MOSFET 112 cannot be shortened, and the operation speed cannot be increased. Moreover, in the process of turning OFF the discharge MOSFET 112, a leakage current of the positive side power path of the battery 130 also causes waste of electric energy.

In the turn-OFF process of the discharge MOSFET 112, the potential of the pack pin voltage Vpack decreases gradually, and the gate-source capacitor of the discharge MOSFET 112 can only be discharged through the parasitic conductive resistor of the switch SW2. In this way, the discharge pin voltage Vdsg of the discharge control pin DSG cannot be lower than the battery pack high-voltage end PACK+ (that is, the pack pin voltage Vpack) for a long period of time (the time point t1 to the time point t2), that is, it is impossible to reduce the gate-source voltage of the discharge MOSFET 112 to zero potential or lower than the conduction threshold voltage of the discharge MOSFET 112 within a short period of time (generally speaking, the period from the time point t1 to the time point t2 is about tens of milliseconds to hundreds of milliseconds). As a result, in the process of turning OFF the discharge MOSFET, the discharge MOSFET 112 cannot be turned OFF quickly and completely, and the output current Iout is higher than zero current, thereby causing waste of electric energy. In addition, when the battery management system 100 of the conventional art needs to activate the over-current protection mechanism, the discharge MOSFET 112 cannot be turned OFF quickly, and the entire battery 130 will be in the over-current state for a long time period, which is easy to be damaged. Especially in the application where the pack pin voltage Vpack exceeds 40 volts (V), the waste of time and power caused by the inability to reduce the gate-source voltage of the discharge MOSFET 112, and the problem of circuit damage caused by over-current are more serious.

In view of this, the present invention aims at the deficiencies of the above-mentioned conventional art, and proposes a battery management system and its control circuit and control method, which can shorten the time period for turning OFF the discharge MOSFET process from tens of milliseconds to hundreds of milliseconds (ms) of the conventional art to several microseconds (us), and can improve the safety of the battery to prolong the life of the battery.

### SUMMARY OF THE INVENTION

The present invention provides a battery management system, comprising: a metal oxide semiconductor field effect transistor (MOSFET) unit, which includes a charge MOSFET and a discharge MOSFET, and is coupled to a positive side power path to control a charge/discharge current to charge/discharge a battery; and a control circuit, which is configured to operably control the charge MOSFET and the discharge MOSFET; wherein the control circuit electrically connects a gate-source capacitor of the discharge MOSFET to a discharge level to discharge the gate-source capacitor of the discharge MOSFET in a discharge-proceeding mode of a process of turning OFF the discharge MOSFET, and determines to operate in a discharge-termination mode to stop discharging the gate-source capacitor of the discharge MOSFET according to a difference between a pack pin voltage and a discharge pin voltage; wherein the discharge level is lower than the pack pin voltage.

From another perspective, the present invention provides a control circuit, which is used in a battery management system to control a metal oxide semiconductor field effect transistor (MOSFET) unit of a battery, wherein the MOSFET unit includes a charge MOSFET and a discharge MOSFET, and is coupled to a positive side power path to control a charge/discharge current to charge/discharge the battery, the control circuit comprising: a subtraction circuit, which is configured to operably perform a subtraction operation on a pack pin voltage and a discharge pin voltage to generate a difference voltage in a process of turning OFF the discharge MOSFET; a comparison circuit, which is configured to operably compare the difference voltage with a first reference voltage to generate a comparison result signal; and a discharge circuit, which is configured to operably determine to enter a discharge-proceeding mode or a discharge-termination mode according to the comparison result signal; wherein the discharge circuit electrically connects the gate-source capacitor of the discharge MOSFET to a discharge level in the discharge-proceeding mode, so as to discharge the gate-source capacitor of the discharge MOSFET; wherein the discharge circuit enters the discharge-termination mode according to the difference voltage; wherein the discharge level is lower than the pack pin voltage.

From another perspective, the present invention provides a control method of a battery management system, comprising: controlling a charging/discharge current to charge/discharge a battery by a metal oxide semiconductor field effect transistor (MOSFET) unit, wherein the MOSFET unit includes a charge MOSFET and a discharge MOSFET and coupled to a positive side power path; and electrically connecting a gate-source capacitor of the discharge MOSFET to a discharge level to discharge the gate-source capacitor of the discharge MOSFET in a discharge-proceeding mode of a process of turning OFF the discharge MOSFET, and determining to operate in a discharge-termination mode to stop discharging the gate-source capacitor of the discharge MOSFET according to a difference between a pack pin voltage and a discharge pin voltage; wherein the discharge level is lower than the pack pin voltage.

In one embodiment, the control circuit includes: a subtraction circuit, which is configured to operably perform a subtraction operation on the pack pin voltage and the discharge pin voltage to generate a difference voltage; a comparison circuit, which is configured to operably compare the difference voltage with a first reference voltage to generate a comparison result signal to determine to operate in the discharge-termination mode; and a discharge circuit, which is configured to operably determine to enter the discharge-proceeding mode or the discharge-termination mode according to the comparison result signal.

In one embodiment, the comparison circuit includes: a first comparator, which is configured to operably compare the difference voltage with the first reference voltage to generate a reset signal; and a logic circuit, which is configured to determine the comparison result signal according to the reset signal and a set signal; wherein the set signal is which is configured to operably set the comparison result signal to indicate that the discharge circuit enters the discharge-proceeding mode; wherein when the difference voltage is an enable level, the comparison result signal is reset to indicate that the discharge circuit enters the discharge-termination mode.

In one embodiment, the set signal includes a clock signal, which is used as the set signal to indicate that the discharge circuit enters the discharge-proceeding mode when the clock signal is at the enable level.

In one embodiment, the comparison circuit further includes a second comparison circuit for comparing the difference voltage with a second reference voltage to generate the set signal; wherein when the set signal is at the enable level, the discharge circuit enters the discharge-proceeding mode.

In one embodiment, the discharge circuit includes: a slope control circuit, which is coupled to the comparison circuit, and is configured to operably charge/discharge a capacitor of the slope control circuit according to the comparison result signal; and a transconductance circuit, which is coupled with the slope control circuit and the discharge MOSFET, and is configured to operably generate a sink current to discharge the gate-source capacitor of the discharge MOSFET according to a capacitor voltage of the capacitor, so as to enter to the discharge-proceeding mode or the discharge-termination mode.

In one embodiment, the slope control circuit includes: a rising slope control circuit, which is configured to operably charge the capacitor when the comparison result signal indicates entering the discharge-proceeding mode, and gradually increase the sink current to increase a discharge rate of discharging the gate-source capacitor of the discharge MOSFET; and a descending slope control circuit, which is configured to operably discharge the capacitor when the comparison result signal indicates entering the discharge-termination mode, and gradually reduce the sink current to reduce the discharge rate of discharging the gate-source capacitor of the discharge MOSFET.

In one embodiment, the discharge circuit further includes a clamping circuit coupled to the capacitor for clamping the capacitor voltage to limit a level of the sink current.

In one embodiment, the clamping circuit includes: a clamping amplifier, which is configured to operably compare the capacitor voltage with a clamp threshold voltage to generate a clamping signal; and a discharge switch, which is configured to operably discharge the capacitor when the capacitor voltage exceeds the clamp threshold voltage according to the clamping signal, so as to clamp the capacitor voltage at the clamp threshold voltage.

In one embodiment, the discharge level is a ground level.

In one embodiment, the first reference voltage is related to a gate-source withstand voltage of the discharge MOSFET.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a battery management system of the conventional art.

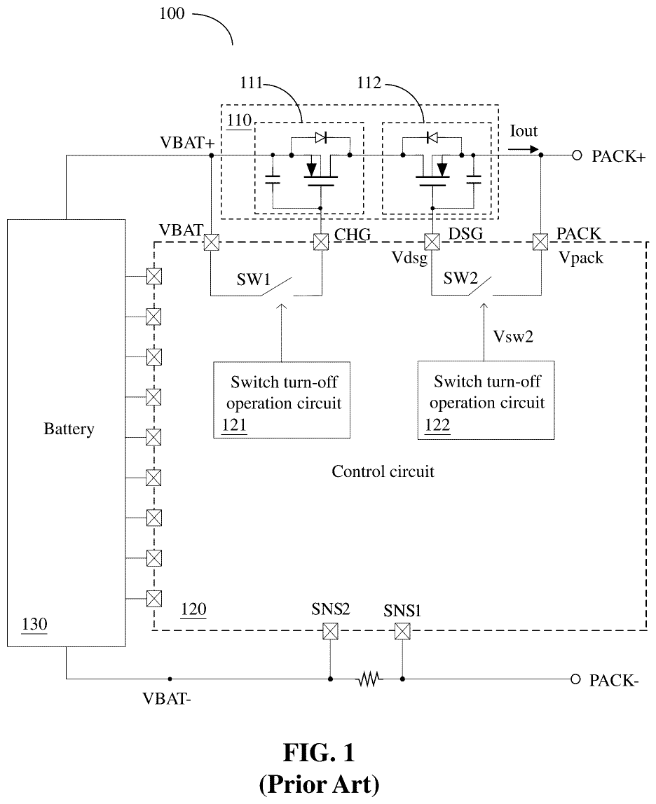

FIG. 2 shows a schematic waveform diagram of related signals of a battery management system of the conventional art.

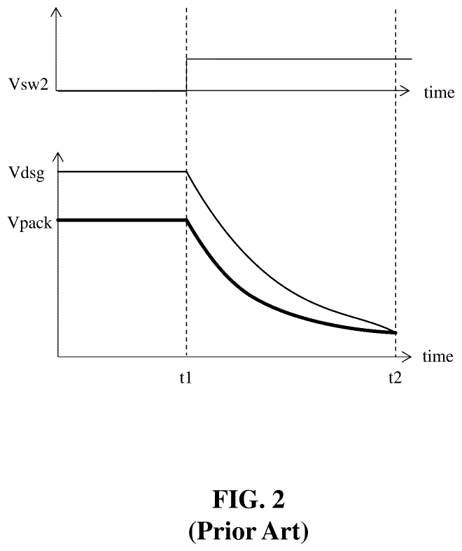

FIG. 3 shows a schematic diagram of the battery management system of an embodiment of the present invention.

FIG. 4 shows a schematic diagram of the battery management system of an embodiment of the present invention.

FIG. 5 shows a schematic diagram of the battery management system of an embodiment of the present invention.

FIG. 6 shows a schematic waveform diagram of related signals of the battery management system in the process of turning OFF the discharge metal oxide semiconductor field effect transistor (MOSFET) of an embodiment of the present invention.

FIG. 7 shows a schematic waveform diagram of related signals of the battery management system in the process of turning OFF the discharge MOSFET of an embodiment of the present invention.

FIG. 8 shows a schematic diagram of the battery management system of an embodiment of the present invention.

FIG. 9 shows a schematic diagram of the battery management system of an embodiment of the present invention.

FIG. 10 is a schematic waveform diagram of related signals of the battery management system in the process of turning OFF the discharge MOSFET of an embodiment of the present invention.

FIG. 11 shows a schematic diagram of the battery management system of an embodiment of the present invention.

FIG. 12 is a schematic waveform diagram of related signals of the battery management system in the process of turning OFF the discharge MOSFET of an embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale.

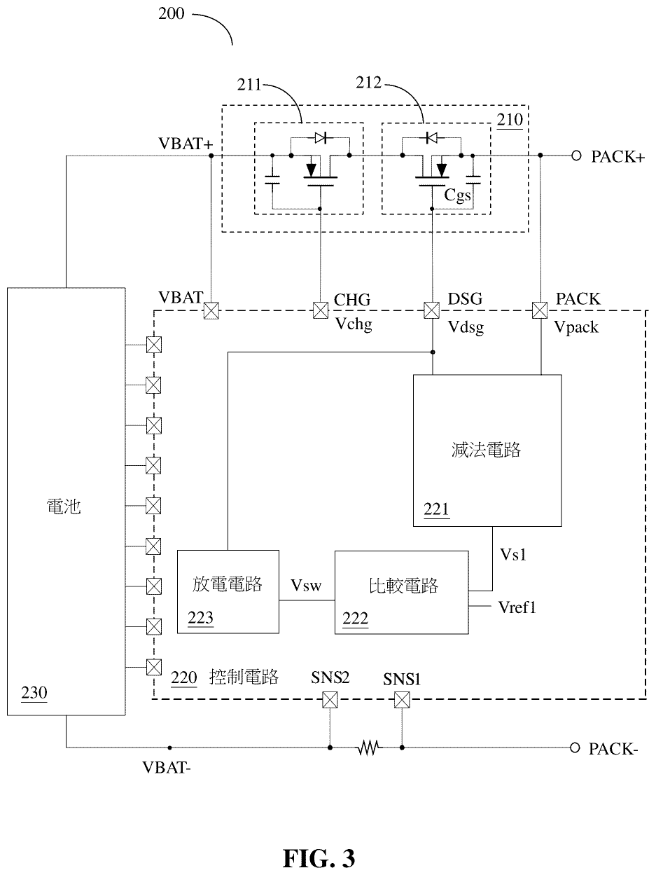

Please refer to FIG. 3, which is a schematic diagram of a battery management system of an embodiment of the present invention. As shown in FIG. 3, the battery management system 200 includes a metal oxide semiconductor field effect transistor (MOSFET) unit 210 and a control circuit 220. The MOSFET unit 210 includes a charge MOSFET 211 and a discharge MOSFET 212 for coupling to a positive power path of the battery 230 to control a charging/discharging current of the battery 230 to charge/discharge the battery 230. When N-type MOSFET (NMOSFET) is used as a charge MOSFET 211 and a discharge MOSFET 212, the MOSFET unit 210 is coupled to the positive side power path of battery 230, that is, between the battery positive voltage end VBAT+ and the battery pack positive voltage end PACK+, to control the charging/discharging current of the battery 230, which is well known to those skilled in the art, so details thereof are omitted here.

It should be noted that the charge MOSFET 211 and the discharge MOSFET 212 are not limited to being connected in series between the battery voltage pin VBAT and the battery pack pin PACK as shown in FIG. 3, and other coupling methods are also possible. For example, the charging MOSFET 211 and the discharging MOSFET 212 are connected in parallel between the battery voltage pin VBAT and the battery pack pin PACK, as long as the charging and discharging of the battery 230 can be controlled. It is known to those skilled in the art of the present invention, so it will not be described in detail.

Please continue to refer to FIG. 3, the control circuit 220 is used to generate a charge pin voltage Vchg and a discharge pin voltage Vdsg to control the charge MOSFET 211 and the discharge MOSFET 212, respectively. The control circuit 220 electrically connects a gate-source capacitor Cgs of the discharge MOSFET 212 to a discharge level to discharge the gate-source capacitor Cgs of the discharge MOSFET 212 in a discharge-proceeding mode of a process of turning OFF the discharge MOSFET, and determines to operate in a discharge-termination mode to stop discharging the gate-source capacitor Cgs of the discharge MOSFET 212 according to a difference between a pack pin voltage Vpack and a discharge pin voltage Vdsg, wherein the discharge level is lower than the pack pin voltage Vpack. In a preferred embodiment, the discharge level is a fixed level. In a more preferred embodiment, the discharge level is a ground level.

It should be noted that capacitors coupled between the gate and the source shown in charge MOSFET 211 and discharge MOSFET 212 are equivalent gate-source capacitors of the MOSFET devices respectively, and diodes shown in the charge MOSFET 211 and the discharge MOSFET 212 coupled between the source and the drain respectively are body diodes of the MOSFET devices, the same below.

It should be noted that the so-called “stop discharging the gate-source capacitor Cgs of the discharge MOSFET 212” can be stopping discharging the gate-source capacitor Cgs of the discharge MOSFET 212 immediately, and it is also possible to be gradually stopping or stepwise stopping discharging the gate-source capacitor Cgs of the discharge MOSFET 212. The purpose is to prevent the difference between the pack pin voltage Vpack and the discharge pin voltage Vdsg from exceeding a gate-source withstand voltage of the discharge MOSFET 212, causing damage to the discharge MOSFET 212.

Please still referring to FIG. 3, in this embodiment, the control circuit 220 includes: a subtraction circuit 221, a comparison circuit 222, and a discharge circuit 223. The subtraction circuit 221 is used to perform a subtraction operation on the pack pin voltage Vpack and the discharge pin voltage Vdsg to generate a difference voltage Vs1. The comparison circuit 222 is configured to compare the difference voltage Vs1 with a first reference voltage Vref1 to generate a comparison result signal Vsw for determining whether to operate in the discharge-termination mode or not. The discharge circuit 223 is configured to enter a discharge-proceeding mode or a discharge-termination mode according to the comparison result signal Vsw, so as to discharge or terminate the discharge of the gate-source capacitor Cgs of the discharge MOSFET.

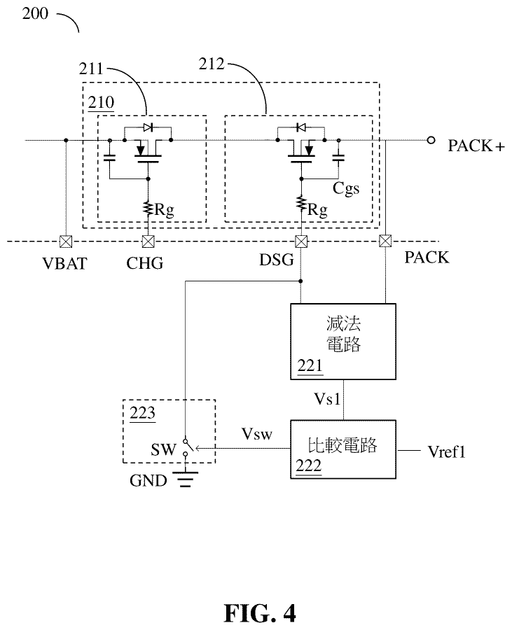

FIG. 4 shows a schematic diagram of the battery management system of an embodiment of the present invention. In this embodiment, the discharge circuit 223 includes, for example, a switch SW. In addition, in the MOSFET unit 210, each of the charge MOSFET 211 and the discharge MOSFET 212 further includes a resistor Rg, wherein one of the resistors Rg is coupled between the gate of the charge MOSFET 211 and the charge control pin CHG, and the other one of the resistors Rq is coupled between the gate of the discharge MOSFET 212 and the discharge control pin DSG. The switch SW is, for example, coupled between the discharge control pin DSG and the ground level, and is operated by the comparison result signal Vsw, so that when the difference between the pack pin voltage Vpack and the discharge pin voltage Vdsg does not exceed the first reference voltage Vref1, indicating that it can be operated in the discharge-proceeding mode, and the switch SW is turned ON to electrically connect the gate-source capacitor Cgs of the discharge MOSFET 212 to the ground level GND to discharge the gate-source capacitor Cgs. Moreover, when the difference between the pack pin voltage Vpack and the discharge pin voltage Vdsg exceeds the first reference voltage Vref1, the discharge-termination mode is entered, the switch SW is turned OFF to electrically disconnect the gate-source capacitor Cgs of the discharge MOSFET 212 and the ground level GND, and the gate-source capacitor Cgs stops discharging.

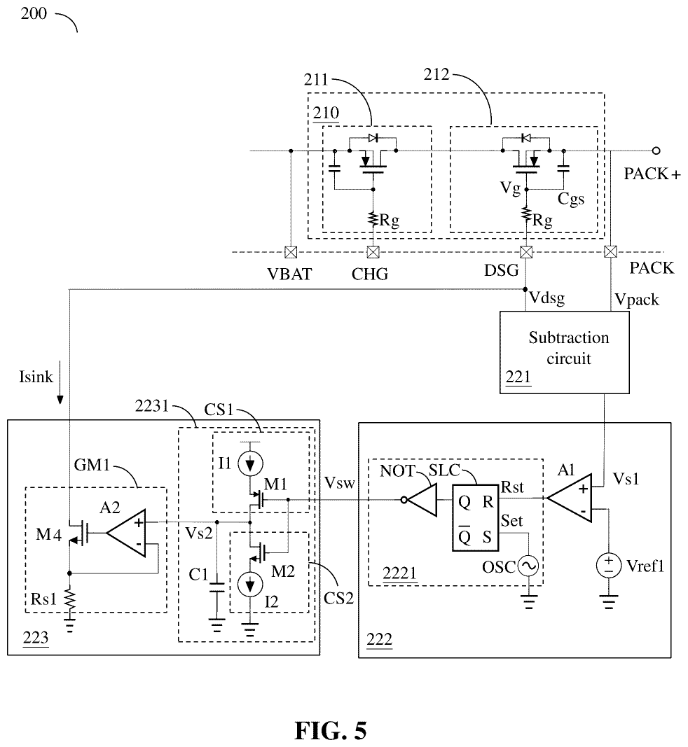

FIG. 5 shows the battery management system of an embodiment of the present invention. This embodiment is a more specific embodiment of the comparison circuit 222 and the discharge circuit 223. As shown in FIG. 5, the comparison circuit 222 includes a first comparator A1 and a logic circuit 2221. The discharge circuit 223 includes a slope control circuit 2231 and a transconductance circuit GM1.

The first comparator A1 is used to compare the difference voltage Vs1 with the first reference voltage Vref1 to generate a reset signal Rst. The logic circuit 2221 is used to determine the comparison result signal Vsw according to the reset signal Rst and the set signal Set. The set signal Set is used to set the comparison result signal Vsw to indicate that the discharge circuit 223 enters the discharge-proceeding mode. When the reset signal Rst is at an enable level, the comparison result signal Vsw is reset to indicate that the discharge circuit 223 enters the discharge-termination mode. In an embodiment, the set signal Set, the reset signal Rst, and the comparison result signal Vsw are, for example, digital signals, represented by an enable level and a disable level.

The first reference voltage Vref1 is generated by a fixed voltage source, such as but not limited to shown in FIG. 5. In a preferrable embodiment, the level of the first reference voltage Vref1 is related to the gate-source withstand voltage of the discharge MOSFET 212, and of course also includes the consideration of the voltage drop of the resistor Rg and the gate-source withstand voltage of the discharge MOSFET 212. The purpose is to limit the difference voltage Vs1 and prevent the discharge MOSFET 212 from damage. For example, when the difference voltage Vs1 indicates that the gate-source voltage of the discharge MOSFET 212 exceeds the gate-source withstand voltage, the discharge MOSFET 212 may be damaged. Therefore, it is necessary to set the level of the first reference voltage Vref1 to a level at which the difference voltage Vs1 can be limited to prevent the discharge MOSFET 212 from damage, and then it is safe to discharge the gate-source capacitor Cgs of the discharge MOSFET 212 in the process of turning OFF the discharge MOSFET. Moreover, before the gate-source voltage of the discharge MOSFET 212 exceeds the gate-source withstand voltage, the discharge of the gate-source capacitor Cgs of the discharge MOSFET is stopped.

In this embodiment, the logic circuit 2221 includes a sequential logic circuit SLC, an oscillator OSC, and an inversion logic gate NOT. In this embodiment, the sequential logic circuit SLC is, for example, an SR latch circuit as shown in FIG. 5, and can also be other flip-flops or a circuit composed of logic gates. In this embodiment, the set signal Set such as but not limited to shown in FIG. 5, the clock signal generated by the oscillator OSC is used as the set signal Set to determine the comparison result signal Vsw. For example, when the clock signal (as the set signal Set) generated by the oscillator OSC is at the enable level, a setting pin S of the input sequential logic circuit SLC makes an output pin Q of the input sequential logic circuit SLC output the enable level, and then through the inversion logic gate NOT, the generated comparison result signal Vsw is the disable level, indicating that the discharge circuit 223 enters and maintains the operation in the discharge-proceeding mode. Until the difference voltage Vs1 exceeds the first reference voltage Vref1, the reset signal Rst is switched from the disable level to the enable level, the reset pin R of the input sequential logic circuit SLC makes the output pin Q output the disable level, and then through the inversion logic gate NOT to switch the comparison result signal Vsw from the disable level to the enable level, so as to indicate that the discharge circuit 223 enters and maintains the operation in the discharge-termination mode until the next clock signal (as the set signal Set) is at the enable level. The aforementioned implementation of the logic circuit 2221 is an implementation and is not intended to limit the scope of the present invention. Those with ordinary knowledge in the art can use other logic circuits to achieve the same effect according to this embodiment, which belongs to scope of the invention.

In short, in this embodiment, when the difference between the pack pin voltage Vpack and the discharge pin voltage Vdsg, that is, the difference voltage Vs1 exceeds the first reference voltage Vref1, the reset signal Rst is switched from the disable level to enable level, and reset the comparison result signal Vsw to the enable level to indicate that the discharge circuit 223 enters the discharge-termination mode to stop discharging the gate-source capacitor Cgs of the discharge MOSFET 212.

Please continue to refer to FIG. 5, the slope control circuit 2231 is coupled to the comparison circuit 222, and charges/discharges the capacitor C1 therein according to the comparison result signal Vsw. The transconductance circuit GM1 is coupled with the slope control circuit 2231 and the discharge MOSFET 212, and generates a sink current Isink to discharge the gate-source capacitor Cgs of the discharge MOSFET 212 according to the capacitor voltage Vs2 of the capacitor C, and then enters the discharge-proceeding mode or the discharge-termination mode.

In this embodiment, the slope control circuit 2231 includes, for example, a rising slope control circuit CS1 and a descending slope control circuit CS2. The rising slope control circuit CS1 is used to charge the capacitor C1 when the comparison result signal Vsw indicates entering the discharge-proceeding mode, and gradually increases the sink current Isink, so as to increase the discharge rate of discharging the gate-source capacitor Cgs of the discharge MOSFET 212. In this embodiment, the descending slope control circuit CS2 is used to discharge the capacitor C1 when the comparison result signal Vsw indicates entering the discharge-termination mode, and gradually reduces the sink current Isink, so as to reduce the discharge rate of discharging the gate-source capacitor Cgs of the discharge MOSFET 212. The transconductance circuit GM1 includes, for example, an amplifier A2, an NMOS device M3, and a resistor Rs1. The non-inverting input end of the amplifier A2 receives the capacitor voltage Vs2, the inverting input end of the amplifier A2 is coupled between the source of the NMOS device M3 and the resistor Rs1, the gate of the NMOS device M3 receives the output signal of the amplifier A2, and the drain of the NMOS device M3 is coupled to the discharge control pin DSG. The resistor Rs1 is coupled between the source of the NMOS device M3 and the ground level.

As shown in FIG. 5, the rising slope control circuit CS1 includes, for example, a current source I1 and a PMOS device M1, and the descending slope control circuit CS2 includes, for example, a current source I2 and an NMOS device M2. When the comparison result signal Vsw is at a disable level, for example, a logic low level, the PMOS device M1 is turned ON, and the NMOS device M2 is turned OFF, the current source I1 supplies current to charge the capacitor C1, so that the capacitor voltage Vs2 gradually increases, and the transconductance circuit GM1 converts the capacitor voltage Vs2 into the sink current Isink, so that the sink current Isink gradually increases, so as to increase the discharge rate of discharging the gate-source capacitor Cgs of the discharge MOSFET 212, and indicating that the discharge circuit 223 enters and maintains the operation in the discharge-proceeding mode, and the discharge pin voltage Vdsg can be reduced to completely turn OFF the discharge MOSFET 212 in a short time period. Meanwhile, the sink current Isink1 is equal to the capacitor voltage Vs2 divided by the resistor Rs1. Compared with the conventional art, the operating efficiency of the battery management system can be greatly improved according to the battery management system and its control circuit and control method of the present invention, moreover, the waste of electric energy during the period of turning OFF the discharge MOSFET can be reduced, and the current protection mechanism can be quickly completed to improve the availability rate of the battery management system.

On the other hand, when the comparison result signal Vsw is at an enable level, such as a logic high level, the PMOS device M1 is turned OFF, the NMOS device M2 is turned ON, and the current source I2 provides current to discharge the capacitor C1, so that the capacitor voltage Vs2 decreases gradually. The transconductance circuit GM1 converts the capacitor voltage Vs2 into the sink current Isink, and the sink current Isink decreases gradually, so as to reduce the discharge rate of discharging the gate-source capacitor Cgs of the discharge MOSFET 212, and indicating that the discharge circuit 223 enters and maintains the operation in the discharge-termination mode to prevent the difference between the pack pin voltage Vpack and the discharge pin voltage Vdsg from exceeding the gate-source withstand voltage of the discharge MOSFET 212, causing damage to the discharge MOSFET 212.

It should be noted that the embodiment shown in FIG. 5 is one of the implementations according to the present invention. According to the teachings of the present invention, the discharge circuit 223 can be implemented with other circuits, as long as when the comparison result signal indicates to enter the discharge-proceeding mode, start to electrically connect the gate-source capacitor of the discharge MOSFET to a discharge level lower than the pack pin voltage to discharge the gate-source capacitor of the discharge MOSFET, and when the comparison result signal indicates to enter the discharge-termination mode, the sink current is reduced immediately or gradually, immediately or gradually stop the gate-source capacitor of the discharge MOSFET from being electrically connected to a discharge level lower than the pack pin voltage, so as to immediately or gradually stop the discharge function of the gate-source capacitor of the discharge MOSFET.

For example, in another embodiment, the descending slope control circuit CS2 can be, for example, a switch. When the comparison result signal Vsw is at an enable level, such as a logic high level, the switch is turned ON, the capacitor C1 is discharged in a relatively short time period, the capacitor voltage Vs2 immediately drops to the ground level, the sink current Isink immediately turns to zero current to immediately stop discharging the gate-source capacitor Cgs of the discharge MOSFET 212, and indicating that the discharge circuit 223 enters and maintains the operation in the discharge-termination mode to prevent the difference between the pack pin voltage Vpack and the discharge pin voltage Vdsg from exceeding the gate-source withstand voltage of the discharge MOSFET 212, causing damage to the discharge MOSFET 212.

It should be noted that when the sink current Isink1 is a non-zero current, the gate-source capacitor Cgs of the discharge MOSFET 212 can be discharged, the discharge pin voltage Vdsg of the discharge control pin DSG will be pulled down, and the pack pin voltage Vpack of the battery pack pin PACK will also decrease at the same time. The subtraction circuit 221 performs a subtraction operation on the pack pin voltage Vpack and the discharge pin voltage Vdsg, and outputs a subtracted difference voltage Vs1, which can also be further adjusted in proportion. For example, the difference voltage Vs1 is calculated by the following equation:

Vs1=K*(Vpack−Vdsg)

wherein a parameter K can be positive or negative.

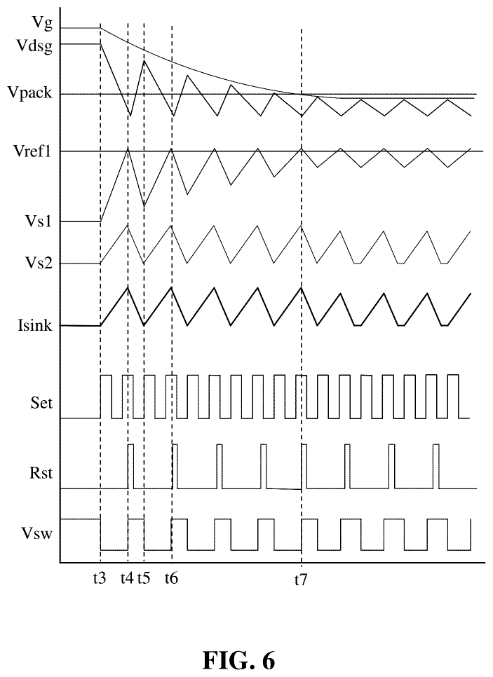

FIG. 6 shows a schematic waveform diagram of related signals of the battery management system in the process of turning OFF the discharge MOSFET of an embodiment of the present invention. Please refer to the embodiment shown in FIG. 5 at the same time. As shown in FIG. 6, the set signal Set such as but not limited to shown in FIG. 5., the clock signal generated by the oscillator OSC is used as the set signal Set. At a time point t3, the set signal Set is switched from a logic low level to a logic high level, indicating an enable level, so that the comparison result signal Vsw is switched from a logic high level to a logic low level, indicating a disable level, and indicating that the discharge circuit 223 starts to enter and maintain the operation in the discharge-proceeding mode. Meanwhile, the PMOS device M1 is switched ON, and the NMOS device M2 is switched OFF. The current source I1 supplies current and starts to charge the capacitor C1, so that the capacitor voltage Vs2 begins to increase gradually, and the sink current Isink is also gradually increased. The discharge rate of discharging the gate-source capacitor Cgs of the discharge MOSFET 212 increases, and the discharge pin voltage Vdsg begins to decrease, so that the difference voltage Vs1 generated by the pack pin voltage Vpack minus the discharge pin voltage Vdsg begins to gradually increase.

At a time point t4, the difference voltage Vs1 generated by the pack pin voltage Vpack minus the discharge pin voltage Vdsg exceeds the first reference voltage Vref1. The reset signal Rst is switched from a logic low level to a logic high level, and the comparison result signal Vsw is reset, so that the comparison result signal Vsw is switched from a logic low level to a logic high level, indicating that the discharge circuit 223 enters the discharge-termination mode. At this time, that is, at the time point t4, the PMOS device M1 is switched OFF, the NMOS device M2 is switched ON, the current source I2 supplies current and starts to discharge the capacitor C1, so that the capacitor voltage Vs2 begins to decrease gradually. The transconductance circuit GM1 converts the capacitor voltage Vs2 to the sink current Isink, so that the sink current Isink also begins to decrease gradually. The discharge rate of discharging the gate-source capacitor Cgs of the discharge MOSFET 212 begins to decrease, and the discharge pin voltage Vdsg begins to increase, so that the difference voltage Vs1 generated by the pack pin voltage Vpack minus the discharge pin voltage Vdsg begins to gradually decrease, and the discharge pin voltage Vdsg begins to gradually increase.

At a time point t5, the set signal Set is switched from a logic low level to a logic high level, and returning to the situation at the time point t3. The discharge circuit 223 starts to enter and maintain the operation in the discharge-proceeding mode again, and increases the rate of discharging the gate-source capacitor Cgs of the discharge MOSFET 212 until a time point t6. The difference voltage Vs1 generated by the pack pin voltage Vpack minus the discharge pin voltage Vdsg exceeds the first reference voltage Vref1 again, and returning to the situation at the time point t4. The discharge circuit 223 starts to enter and maintain the operation in the discharge-termination mode again, and reduces the rate of discharging the gate-source capacitor Cgs of the discharge MOSFET 212. In this way, the discharge circuit 223 is alternately operated in the discharge-proceeding mode and the discharge-termination mode, and only needs to repeat several alternate operations in the discharge-proceeding mode and the discharge-termination mode, the gate voltage Vg of the discharge MOSFET 212 can be lowered to below the pack pin voltage Vpack, and turn OFF the discharge MOSFET 212 completely. From the time point t3 to a time point t7 is about a few microseconds, which shortens the time period by tens of thousands to hundreds of thousands of times compared with the tens of milliseconds to hundreds of milliseconds of the conventional art, and significantly improves the operating efficiency. This is one of the advantages of the present invention over the conventional art.

It should be noted that, in an embodiment, the set signal Set, the reset signal Rst, and the comparison result signal Vsw are, for example, digital signals, so as to indicate the enable level and the disable level. The signal waveforms of the discharge pin voltage Vdsg, the difference voltage Vs1, the capacitor voltage Vs2, and the sink current Isink are sawtooth waves or triangular waves.

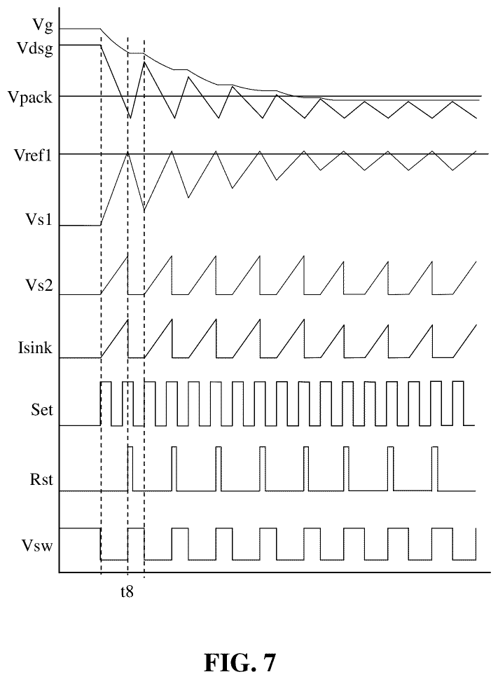

FIG. 7 shows a schematic waveform diagram of related signals of the battery management system in the process of turning OFF the discharge MOSFET of an embodiment of the present invention. The embodiment shown in FIG. 7 is similar to the embodiment shown in FIG. 6, and the difference from the implementation shown in FIG. 6 lies in the embodiment of the battery management system corresponding to FIG. 7, as mentioned in the description of the embodiment in FIG. 5, the descending slope control circuit CS2 can be, for example, a switch. When the comparison result signal Vsw is switched to an enable level at a time point t8, such as a logic high level, the switch is turned ON, and the capacitor C1 is discharged in a relatively short time period, so that the capacitor voltage Vs2 immediately drops to the ground level at the time point t8, and the sink current Isink is also immediately turned to zero current at the time point t8, so as to immediately stop discharging the gate-source capacitor Cgs of the discharge MOSFET 212, and indicating that the discharge circuit 223 enters and maintains the operation in the discharge-termination mode to prevent the difference between the pack pin voltage Vpack and the discharge pin voltage Vdsg from exceeding the gate-source withstand voltage of the discharge MOSFET 212, causing damage to the discharge MOSFET 212.

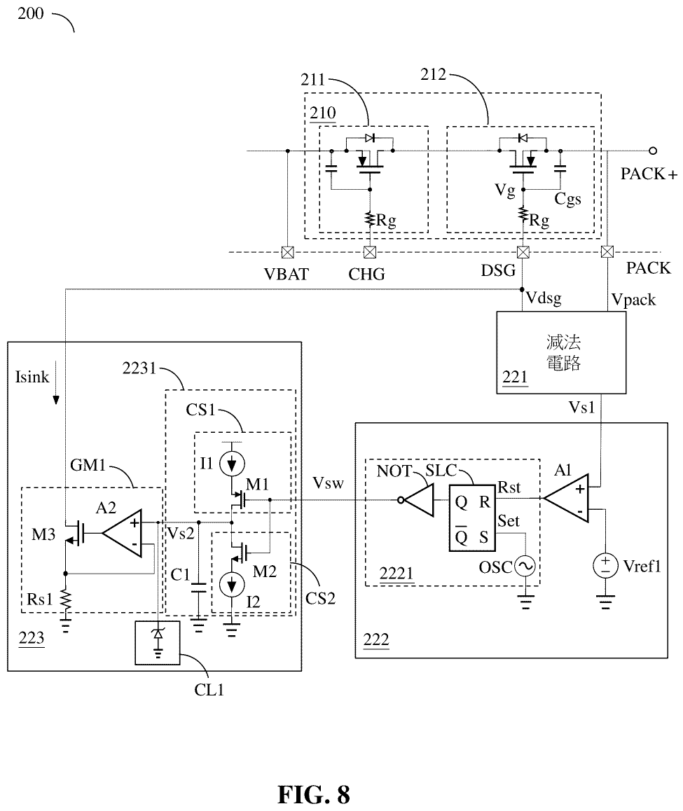

FIG. 8 shows an embodiment of the battery management system of the present invention. Compared with the embodiment shown in FIG. 5, this embodiment indicates that the discharge circuit further includes a clamping circuit. As shown in FIG. 8, the clamping circuit CL1 is coupled to the capacitor C1 for clamping the capacitor voltage Vs2 to limit the level of the sink current Isink. As shown in FIG. 8, the clamping circuit CL1 includes, for example but not limited to, a Zener diode to clamp the capacitor voltage Vs2. The operation method of the Zener diode is well known to those skilled in the art, and will not be repeated here. A function of setting the clamping circuit CL1 is to limit the level of the sink current Isink, so as to prevent the circuit from damage caused by the sink current Isink being too high.

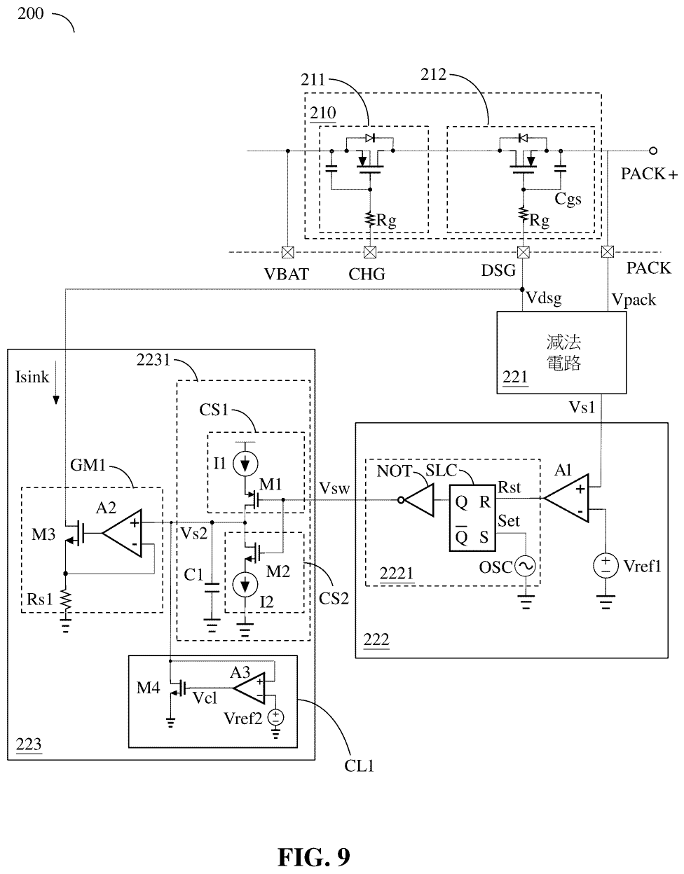

FIG. 9 shows an embodiment of the battery management system of the present invention. Compared with the embodiment shown in FIG. 8, this embodiment is another embodiment of the clamping circuit CL1. As shown in FIG. 9, the clamping circuit CL1 includes a clamping amplifier A3, a discharge switch M4, and a voltage source. The clamping amplifier A3 is configured to compare the capacitor voltage Vs2 with the clamp threshold voltage Vref2 provided by the voltage source to generate a clamping signal Vcl. The discharge switch M4 is used to discharge the capacitor C1 when the capacitor voltage Vs2 exceeds the clamp threshold voltage Vref2 according to the clamping signal Vcl, so as to clamp the capacitor voltage Vs2 to the clamp threshold voltage Vref2. In this embodiment, the non-inverting end of the clamping amplifier A3 is coupled to the slope control circuit 2231 to receive the capacitor voltage Vs2. The inverting end of the clamping amplifier A3 is coupled to a voltage source to receive the clamp threshold voltage Vref2. In this embodiment, the discharge switch M4 is coupled to the clamping amplifier A3 and the slope control circuit 2231, and is controlled by the clamping signal Vcl to limit the capacitor voltage Vs2 to the clamp threshold voltage Vref2.

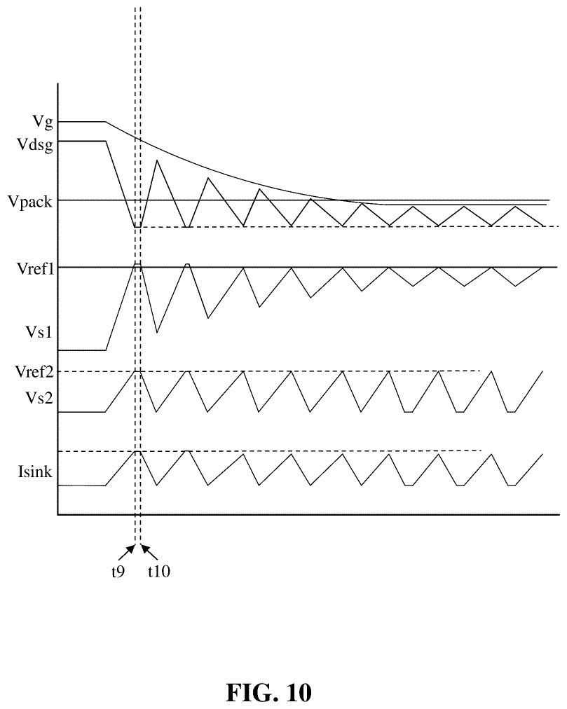

FIG. 10 shows a schematic waveform diagram of related signals of the battery management system in the process of turning OFF the discharge MOSFET of an embodiment of the present invention. Please also refer to the embodiment shown in FIG. 9. FIG. 10 is intended to illustrate that during the period from a time point t9 to a time point t10, when the capacitor voltage Vs2 reaches the clamp threshold voltage Vref2, it is limited by the clamping circuit CL1 and maintained at the clamp threshold voltage Vref2, so as to limit the level of the sink current Isink, thereby preventing the circuit from damage caused by the sink current Isink being too high.

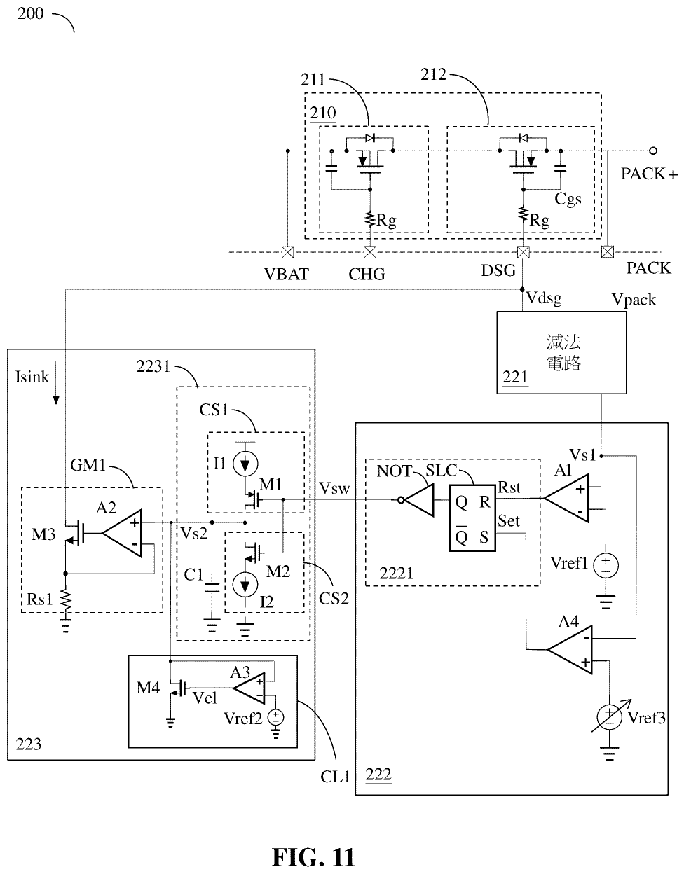

FIG. 11 shows a schematic diagram of the battery management system of an embodiment of the present invention. Compared with the embodiment shown in FIG. 5, the purpose of this embodiment is to show that the comparison circuit 222 does not include the oscillator OSC, but further includes a second comparison circuit A4 for comparing the difference voltage Vs1 with the second reference voltage Vref3 to generate a set signal Set. That is to say, as shown in FIG. 11, the set signal Set, such as but not limited to shown in FIG. 11, is generated by the second comparison circuit A4 comparing the difference voltage Vs1 with the second reference voltage Vref3, and then determines the comparison result signal Vsw. The second reference voltage Vref3, such as but not limited to shown in FIG. 11, is generated by a controllable voltage source, and the second reference voltage Vref3 is a controllable voltage signal. Other operations are the same as the embodiment shown in FIG. 5, please refer to the description of the embodiment shown in FIG. 5.

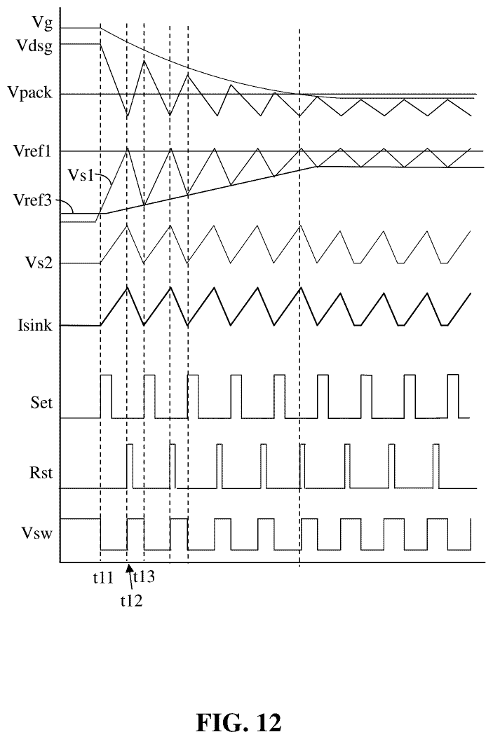

FIG. 12 is a schematic waveform diagram of related signals of the battery management system in the process of turning OFF the discharge MOSFET of an embodiment of the present invention. FIG. 12 is intended to show a schematic waveform diagram of related signals of the embodiment shown in FIG. 11. As shown in FIG. 12, and referring to FIG. 11, at a time point t11, the process of turning OFF the discharge MOSFET starts, meanwhile, the second reference voltage Vref3 is higher than the difference voltage Vs1. The second comparison circuit A4 compares the difference voltage Vs1 with the second reference voltage Vref3, and the generated set signal Set is switched to a logic high level, which is indicated as an enable level. The comparison result signal Vsw is switched from a logic high level to a logic low level, which is indicated as a disable level, so as to indicate that the discharge circuit 223 starts to enter and maintain the operation in the discharge-proceeding mode. At this time, the PMOS device M1 is switched ON, and the NMOS device M2 is switched OFF. The current source I1 supplies current and starts to charge the capacitor C1, so that the capacitor voltage Vs2 begins to increase gradually, and the sink current Isink also increases gradually, the discharge rate of discharging the gate-source capacitor Cgs of the discharge MOSFET increases. The discharge pin voltage Vdsg begins to decrease, so that the difference voltage Vs1 generated by the pack pin voltage Vpack minus the discharge pin voltage Vdsg begins to increase gradually.

At a time point t12, the difference voltage Vs1 generated by the pack pin voltage Vpack minus the discharge pin voltage Vdsg exceeds the first reference voltage Vref1, the reset signal Rst is switched from a logic low level to a logic high level, and the comparison result signal Vsw is reset, so that the comparison result signal Vsw is switched from a logic low level to a logic high level to indicate that the discharge circuit 223 enters the discharge-termination mode. At this time, that is, at the time point t4, the PMOS device M1 is switched OFF, the NMOS device M2 is switched ON, the current source I2 supplies current and starts to discharge the capacitor C1, so that the capacitor voltage Vs2 begins to decrease gradually. The transconductance circuit GM1 converts the capacitor voltage Vs2 to the sink current Isink, so that the sink current Isink also begins to decrease gradually. The discharge rate of discharging the gate-source capacitor Cgs of the discharge MOSFET 212 begins to decrease, and the discharge pin voltage Vdsg begins to increase, so that the difference voltage Vs1 generated by the pack pin voltage Vpack minus the discharge pin voltage Vdsg begins to decrease gradually, and the discharge pin voltage Vdsg begins to increase gradually until a time point t13. When the second reference voltage Vref3 is higher than the difference voltage Vs1 again, and the set signal Set generated by the second comparison circuit A4 comparing the difference voltage Vs1 and the second reference voltage Vref3 is switched to a logic high level, indicating an enable level. To sum up, when the difference voltage Vs1 increases to exceed the first reference voltage Vref1, indicating that the discharge circuit 223 enters the discharge-termination mode, and when the difference voltage Vs1 decreases to exceed the second reference voltage Vref3, indicating that the discharge circuit 223 enters and maintains the operation in discharge-proceeding mode.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, other process steps or structures, such as a metal silicide layer, may be added. For another example, the lithography process step is not limited to the mask technology but it can also include electron beam lithography, immersion lithography, etc. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. A battery management system, comprising:
a metal oxide semiconductor field effect transistor (MOSFET) unit, which includes a charge MOSFET and a discharge MOSFET, and is coupled to a positive side power path to control a charge/discharge current to charge/discharge a battery; and
a control circuit, which is configured to operably control the charge MOSFET and the discharge MOSFET;
wherein the control circuit electrically connects a gate-source capacitor of the discharge MOSFET to a discharge level to discharge the gate-source capacitor of the discharge MOSFET in a discharge-proceeding mode of a process of turning OFF the discharge MOSFET, and determines to operate in a discharge-termination mode to stop discharging the gate-source capacitor of the discharge MOSFET according to a difference between a pack pin voltage and a discharge pin voltage;
wherein the discharge level is lower than the pack pin voltage.

2. The battery management system of claim 1, wherein the control circuit includes:
a subtraction circuit, which is configured to operably perform a subtraction operation on the pack pin voltage and the discharge pin voltage to generate a difference voltage;
a comparison circuit, which is configured to operably compare the difference voltage with a first reference voltage to generate a comparison result signal to determine to operate in the discharge-termination mode; and
a discharge circuit, which is configured to operably determine to enter the discharge-proceeding mode or the discharge-termination mode according to the comparison result signal.

3. The battery management system of claim 2, wherein the comparison circuit includes:
a first comparator, which is configured to operably compare the difference voltage with the first reference voltage to generate a reset signal; and
a logic circuit, which is configured to determine the comparison result signal according to the reset signal and a set signal;
wherein the set signal is which is configured to operably set the comparison result signal to indicate that the discharge circuit enters the discharge-proceeding mode;
wherein when the difference voltage is an enable level, the comparison result signal is reset to indicate that the discharge circuit enters the discharge-termination mode.

4. The battery management system of claim 3, wherein the set signal includes a clock signal, which is used as the set signal to indicate that the discharge circuit enters the discharge-proceeding mode when the clock signal is at the enable level.

5. The battery management system of claim 3, wherein the comparison circuit further includes a second comparison circuit for comparing the difference voltage with a second reference voltage to generate the set signal;
wherein when the set signal is at the enable level, the discharge circuit enters the discharge-proceeding modeenable level.

6. The battery management system of claim 3, wherein the discharge circuit includes:
a slope control circuit, which is coupled to the comparison circuit, and is configured to operably charge/discharge a capacitor of the slope control circuit according to the comparison result signal; and
a transconductance circuit, which is coupled with the slope control circuit and the discharge MOSFET, and is configured to operably generate a sink current to discharge the gate-source capacitor of the discharge MOSFET according to a capacitor voltage of the capacitor, so as to enter to the discharge-proceeding mode or the discharge-termination mode.

7. The battery management system of claim 6, wherein the slope control circuit includes:
a rising slope control circuit, which is configured to operably charge the capacitor when the comparison result signal indicates entering the discharge-proceeding mode, and gradually increase the sink current to increase a discharge rate of discharging the gate-source capacitor of the discharge MOSFET; and
a descending slope control circuit, which is configured to operably discharge the capacitor when the comparison result signal indicates entering the discharge-termination mode, and gradually reduce the sink current to reduce the discharge rate of discharging the gate-source capacitor of the discharge MOSFET.

8. The battery management system of claim 6, wherein the discharge circuit further includes a clamping circuit coupled to the capacitor for clamping the capacitor voltage to limit a level of the sink current.

9. The battery management system of claim 8, wherein the clamping circuit includes:
a clamping amplifier, which is configured to operably compare the capacitor voltage with a clamp threshold voltage to generate a clamping signal; and
a discharge switch, which is configured to operably discharge the capacitor when the capacitor voltage exceeds the clamp threshold voltage according to the clamping signal, so as to clamp the capacitor voltage at the clamp threshold voltage.

10. The battery management system of claim 1, wherein the discharge level is a ground level.

11. A control circuit, which is used in a battery management system to control a metal oxide semiconductor field effect transistor (MOSFET) unit of a battery, wherein the MOSFET unit includes a charge MOSFET and a discharge MOSFET, and is coupled to a positive side power path to control a charge/discharge current to charge/discharge the battery, the control circuit comprising:
a subtraction circuit, which is configured to operably perform a subtraction operation on a pack pin voltage and a discharge pin voltage to generate a difference voltage in a process of turning OFF the discharge MOSFET;
a comparison circuit, which is configured to operably compare the difference voltage with a first reference voltage to generate a comparison result signal; and
a discharge circuit, which is configured to operably determine to enter a discharge-proceeding mode or a discharge-termination mode according to the comparison result signal;
wherein the discharge circuit electrically connects the gate-source capacitor of the discharge MOSFET to a discharge level in the discharge-proceeding mode, so as to discharge the gate-source capacitor of the discharge MOSFET;
wherein the discharge circuit enters the discharge-termination mode according to the difference voltage;
wherein the discharge level is lower than the pack pin voltage.

12. The control circuit of claim 11, wherein the comparison circuit includes:
a first comparator, which is configured to operably compare the difference voltage with the first reference voltage to generate a reset signal; and
a logic circuit, which is configured to operably determine the comparison result signal according to the reset signal and a set signal;
wherein the set signal is used to set the comparison result signal to indicate that the discharge circuit enters the discharge-proceeding mode;
wherein when the difference voltage is an enable level, the comparison result signal is reset to indicate that the discharge circuit enters the discharge-termination mode.

13. The control circuit of claim 12, wherein the set signal includes a clock signal, which is used as the set signal to indicate that the discharge circuit enters the discharge-proceeding mode when the clock signal is at the enable level.

14. The control circuit of claim 12, wherein the comparison circuit further includes a second comparison circuit for comparing the difference voltage with a second reference voltage to generate the set signal;
wherein when the set signal is at the enable level, the discharge circuit enters the discharge-proceeding modeenable level.

15. The control circuit of claim 12, wherein the discharge circuit includes:
a slope control circuit, which is coupled to the comparison circuit, and is configured to operably charge/discharge a capacitor of the slope control circuit according to the comparison result signal; and
a transconductance circuit, which is coupled with the slope control circuit and the discharge MOSFET, and is configured to operably generate a sink current to discharge the gate-source capacitor of the discharge MOSFET according to a capacitor voltage of the capacitor, so as to enter to the discharge-proceeding mode or the discharge-termination mode.

16. The control circuit of claim 15, wherein the slope control circuit includes:
a rising slope control circuit, which is configured to operably charge the capacitor when the comparison result signal indicates entering the discharge-proceeding mode, and gradually increase the sink current to increase a discharge rate of discharging the gate-source capacitor of the discharge MOSFET; and
a descending slope control circuit, which is configured to operably discharge the capacitor when the comparison result signal indicates entering the discharge-termination mode, and gradually reduce the sink current to reduce the discharge rate of discharging the gate-source capacitor of the discharge MOSFET.

17. The control circuit of claim 15, wherein the discharge circuit further includes a clamping circuit, which is coupled to the capacitor, and is configured to operably clamp the capacitor voltage to limit a level of the sink current.

18. The control circuit of claim 17, wherein the clamping circuit includes:
a clamping amplifier, which is configured to operably compare the capacitor voltage with a clamp threshold voltage to generate a clamping signal; and
a discharge switch, which is configured to operably discharge the capacitor when the capacitor voltage exceeds the clamp threshold voltage according to the clamping signal, so as to clamp the capacitor voltage at the clamp threshold voltage.

19. The control circuit of claim 11, wherein the discharge level is a ground level.

20. The control circuit of claim 11, wherein the first reference voltage is related to a gate-source withstand voltage of the discharge MOSFET.

21. A control method of a battery management system, comprising:
controlling a charging/discharge current to charge/discharge a battery by a metal oxide semiconductor field effect transistor (MOSFET) unit, wherein the MOSFET unit includes a charge MOSFET and a discharge MOSFET and coupled to a positive side power path; and
electrically connecting a gate-source capacitor of the discharge MOSFET to a discharge level to discharge the gate-source capacitor of the discharge MOSFET in a discharge-proceeding mode of a process of turning OFF the discharge MOSFET, and determining to operate in a discharge-termination mode to stop discharging the gate-source capacitor of the discharge MOSFET according to a difference between a pack pin voltage and a discharge pin voltage;
wherein the discharge level is lower than the pack pin voltage.

22. The control method of the battery management system of claim 21, wherein the step of electrically connecting the gate-source capacitor of the discharge MOSFET to the discharge level to discharge the gate-source capacitor of the discharge MOSFET in the discharge-proceeding mode of the process of turning OFF the discharge MOSFET, and determining to operate in the discharge-termination mode to stop discharging the gate-source capacitor of the discharge MOSFET according to the difference between the pack pin voltage and the discharge pin voltage includes:
performing a subtraction operation on the pack pin voltage and the discharge pin voltage to generate a difference voltage;
comparing the difference voltage with a first reference voltage to generate a comparison result signal to determine to operate in the discharge-termination mode; and
determining to enter to the discharge-proceeding mode or the discharge-termination mode according to the comparison result signal.

23. The control method of the battery management system of claim 22, wherein the step of comparing the difference voltage with the first reference voltage to generate the comparison result signal to determine to operate in the discharge-termination mode includes:
comparing the difference voltage with the first reference voltage to generate a reset signal; and
determining the comparison result signal according to the reset signal and a set signal;
wherein the set signal is used to set the comparison result signal to indicate that the discharge circuit enters the discharge-proceeding mode;
wherein when the difference voltage is an enable level, the comparison result signal is reset to indicate that the discharge circuit enters the discharge-termination mode.

24. The control method of the battery management system of claim 23, wherein the set signal includes a clock signal, which is used as the set signal to indicate that the discharge circuit enters the discharge-proceeding mode when the clock signal is at the enable level.

25. The control method of the battery management system of claim 23, wherein the step of comparing the difference voltage with the first reference voltage to generate the comparison result signal further includes:
comparing the difference voltage with a second reference voltage to generate the set signal; and
indicating that the discharge circuit enters the discharge-proceeding mode when the set signal is at the enable level.

26. The control method of the battery management system of claim 23, wherein the step of determining to enter to the discharge-proceeding mode or the discharge-termination mode according to the comparison result signal includes:
charging/discharging a capacitor according to the comparison result signal; and
generating a sink current to discharge the gate-source capacitor of the discharge MOSFET according to a capacitor voltage of the capacitor, so as to enter to the discharge-proceeding mode or the discharge-termination mode.

27. The control method of the battery management system of claim 26, wherein the step of charging/discharging the capacitor according to the comparison result signal includes:
charging the capacitor when the comparison result signal indicates entering the discharge-proceeding mode, and gradually increasing the sink current to increase a discharge rate of discharging the gate-source capacitor of the discharge MOSFET; and
discharging the capacitor when the comparison result signal indicates entering the discharge-termination mode, and gradually reducing the sink current to reduce the discharge rate of discharging the gate-source capacitor of the discharge MOSFET.

28. The control method of the battery management system of claim 26, wherein the step of determining to enter to the discharge-proceeding mode or the discharge-termination mode according to the comparison result signal further includes:
comparing the capacitor voltage with a clamp threshold voltage to generate a clamping signal; and
discharging the capacitor when the capacitor voltage exceeds the clamp threshold voltage according to the clamping signal, so as to clamp the capacitor voltage at the clamp threshold voltage.

29. The control method of the battery management system of claim 21, wherein the discharge level is a ground level.

30. The control method of the battery management system of claim 21, wherein the first reference voltage is related to a gate-source withstand voltage of the discharge MOSFET.
